(19) United States
(12) Patent Application Publication
(10) Pub. No.: US 2026/0239215 A1
(43) Pub. Date: Aug. 13, 2026

(54) METHOD AND APPARATUS FOR WIRELESS COMMUNICATION

(71) Applicant: QUECTEL WIRELESS SOLUTIONS CO., LTD., Shanghai (CN)

(72) Inventor: Ling LYU, Frisco, TX (US)

(21) Appl. No.: 19/637,420

(22) Filed: Apr. 2, 2026

Related U.S. Application Data
(63) Continuation of application No. PCT/CN2024/118516, filed on Sep. 12, 2024.

(51) Int. Cl. H04W 52/02

(52) U.S. Cl. CPC H04W 52/0235

(57) ABSTRACT

Disclosed are a method and apparatus for wireless communication. One example method includes: obtaining, while in a wake-up signal monitoring mode, a first measurement result of a measurement signal received by a first communications module, wherein the measurement signal comprises at least one of a wake-up signal, a synchronization signal related to the first communications module, or a synchronization signal block, and the first measurement result indicates a transmission quality of the wake-up signal; determining, based on the first measurement result, whether a first condition for communications module conversion is satisfied, wherein the first condition is related to the first measurement result.

### CROSS-REFERENCE TO RELATED APPLICATIONS

This application is a continuation of International Application No. PCT/CN2024/118516, filed on Sep. 12, 2024, the disclosure of which is hereby incorporated by reference in its entirety.

### TECHNICAL FIELD

The present application relates to the field of communications technologies, and more specifically, to a method and apparatus for wireless communication.

### BACKGROUND

To reduce power consumption of a terminal device caused by detecting paging messages regularly, low-power wake-up signals (low-power wake-up signal, LP-WUS) are introduced in some communication systems. For example, the terminal device may receive an LP-WUS transmitted by a network device through a low-power wake-up module independent of a main communications module. Therefore, how to monitor LP-WUS by the terminal device is a problem that needs to be considered.

### SUMMARY

The present application provides a method and apparatus for wireless communication. Various aspects of embodiments of the present application are described below.

According to a first aspect, a method for wireless communication is provided, where the method is applied to a terminal device including a first communications module and a second communications module. The method includes: determining whether to execute communications mode conversion based on a first condition; where the communications mode conversion includes the first communications module entering a wake-up signal monitoring mode and the first communications module quitting the wake-up signal monitoring mode, the wake-up signal is used to wake up the second communications module, the first condition is related to a first measurement result, and the first measurement result is used to indicate a transmission quality of the wake-up signal.

According to a second aspect, a method for wireless communication is provided, including: determining whether to transmit a wake-up signal to a terminal device based on paging of the terminal device; where the terminal device includes a first communications module and a second communications module, the wake-up signal is used to wake up the second communications module, a first measurement result is used to indicate a transmission quality of the wake-up signal, a first condition is related to the first measurement result, the first condition is used for the terminal device to determine whether to perform communications mode conversion, the communications mode conversion includes the first communications module entering a wake-up signal monitoring mode and the first communications module quitting the wake-up signal monitoring mode.

According to a third aspect, an apparatus for wireless communication is provided, where the apparatus is a terminal device, and the apparatus includes: a determining module, determining whether to execute communications mode conversion based on a first condition; where the terminal device further includes a first communications module and a second communications module, the communications mode conversion includes the first communications module entering a wake-up signal monitoring mode and the first communications module quitting the wake-up signal monitoring mode, the wake-up signal is used to wake up the second communications module, the first condition is related to a first measurement result, and the first measurement result is used to indicate a transmission quality of the wake-up signal.

According to a fourth aspect, an apparatus for wireless communication is provided, where the apparatus is a network device, and the apparatus includes: a determining module, determining whether to transmit a wake-up signal to a terminal device based on paging of the terminal device; where the terminal device includes a first communications module and a second communications module, the wake-up signal is used to wake up the second communications module, a first measurement result is used to indicate a transmission quality of the wake-up signal, a first condition is related to the first measurement result, the first condition is used for the terminal device to determine whether to perform communications mode conversion, the communications mode conversion includes the first communications module entering a wake-up signal monitoring mode and the first communications module quitting the wake-up signal monitoring mode.

According to a fifth aspect, a communications apparatus is provided, including a memory and a processor, where the memory is configured to store a program, and the processor is configured to invoke the program in the memory to execute a method according to the first aspect or the second aspect.

According to a sixth aspect, an apparatus is provided, including a processor, invoking a program from a memory to execute a method according to the first aspect or the second aspect.

According to a seventh aspect, a chip is provided, including a processor, invoking a program from a memory, to cause a device on which the chip is installed to execute a method according to the first aspect or the second aspect.

According to an eighth aspect, a computer-readable storage medium is provided, where the computer-readable storage medium stores a program, and the program causes a computer to execute a method according to the first aspect or the second aspect.

According to a ninth aspect, a computer program product is provided, including a program, where the program causes a computer to execute a method according to the first aspect or the second aspect.

According to a tenth aspect, a computer program is provided, where the computer program causes a computer to execute a method according to the first aspect or the second aspect.

The terminal device in the embodiments of the present application determines whether to activate the first communications module to enter the wake-up signal monitoring mode or to activate the first communications module to quit the wake-up signal monitoring mode according to the first condition. The first condition is related to the first measurement result indicating the transmission quality of the wake-up signal. Thus, the terminal device can perform the communications mode conversion related to wake-up signal monitoring based on coverage or transmission of the wake-up signal, thereby preventing a communications effect from being affected due to waiting for the wake-up signal.

### BRIEF DESCRIPTION OF THE DRAWINGS

FIG. 1 shows a wireless communications system to which embodiments of the present application are applied.

FIG. 2 is a schematic diagram of a possible structure of a low-power wake-up module to which the embodiments of the present application are applied.

FIG. 3 is a schematic diagram of another possible structure of the low-power wake-up module to which the embodiments of the present application are applied.

FIG. 4 is a schematic diagram of yet another possible structure of the low-power wake-up module to which the embodiments of the present application are applied.

FIG. 5 is a schematic flowchart of a method for wireless communication according to an embodiment of the present application.

FIG. 6 is a schematic diagram of a possible implementation of the method shown in FIG. 5.

FIG. 7 is a schematic structural diagram of an apparatus for wireless communication according to an embodiment of the present application.

FIG. 8 is a schematic structural diagram of another apparatus for wireless communication according to an embodiment of the present application.

FIG. 9 is a schematic structural diagram of a communications apparatus according to an embodiment of the present application.

### DETAILED DESCRIPTION OF THE EMBODIMENTS

The following describes the technical solutions in embodiments of the present application with reference to the accompanying drawings in embodiments of the present application. Apparently, the described embodiments are some rather than all of embodiments of the present application. All other embodiments obtained by persons of ordinary skill in the art based on the embodiments of the present application shall fall within the protection scope of the present application.

Embodiments of the present application may be applied to various communications systems. For example, embodiments of the present application may be applied to a global system of mobile communication (global system of mobile communication, GSM) system, time division multiple access (time division multiple access, TDMA), frequency division multiple access (frequency division multiple access, FDMA), orthogonal frequency division multiple access (orthogonal frequency division multiple access, OFDMA), single-carrier frequency division multiple access (single-carrier frequency division multiple access, SC-FDMA), code division multiple access (code division multiple access, CDMA) systems, a wideband code division multiple access (wideband code division multiple access, WCDMA) system, a general packet radio service (general packet radio service, GPRS) system, a long term evolution (long term evolution, LTE) system, an advanced long term evolution (advanced long term evolution, LTE-A) system, a new radio (new radio, NR) system, an evolution system of an NR system, an LTE-based access to unlicensed spectrum (LTE-based access to unlicensed spectrum, LTE-U) system, an NR-based access to unlicensed spectrum (NR-based access to unlicensed spectrum, NR-U) system, a universal mobile telecommunication system (universal mobile telecommunication system, UMTS), a wireless local area networks (wireless local area networks, WLAN) system, a wireless fidelity (wireless fidelity, WiFi) system, and a 5th-generation (5th-generation, 5G) system. Embodiments of the present application may be further applied to another communications system, for example, a future communications system such as a 6th-generation (6th-generation, 6G) mobile communications system or a satellite (satellite) communications system.

Conventional communications systems support a limited quantity of connections and are easy to implement. However, with development of communications technologies, a communications system may support not only conventional cellular communications but also one or more other types of communications. For example, the communications system may support one or more types of the following communication: device-to-device (device to device, D2D) communication, machine-to-machine (machine to machine, M2M) communication, machine type communication (machine type communication, MTC), enhanced machine type communication (enhanced MTC, eMTC), vehicle-to-vehicle (vehicle to vehicle, V2V) communication, vehicle-to-everything (vehicle to everything, V2X) communication, and the like. Embodiments of the present application may also be applied to a communications system that supports the foregoing communication manners.

The communications system in embodiments of the present application may be applied to a carrier aggregation (carrier aggregation, CA) scenario, a dual connectivity (dual connectivity, DC) scenario, or a standalone (standalone, SA) networking scenario.

The communications system in embodiments of the present application may be applied to an unlicensed spectrum. The unlicensed spectrum may also be considered as a shared spectrum. Alternatively, the communications system in embodiments of the present application may be applied to a licensed spectrum. The licensed spectrum may also be considered as a dedicated spectrum.

Embodiments of the present application may be applied to a non-terrestrial network (non-terrestrial network, NTN) system. As an example, the NTN system may be a 4G-based NTN system, an NR-based NTN system, an NTN system based on an internet of things (internet of things, IOT), or an NTN system based on a narrow band internet of things (narrow band internet of things, NB-IOT).

The communications system may include one or more terminal devices. The terminal device in embodiments of the present application may also be referred to as user equipment (user equipment, UE), an access terminal, a subscriber unit, a subscriber station, a mobile site, a mobile station (mobile station, MS), a mobile terminal (mobile Terminal, MT), a remote station, a remote terminal, a mobile device, a user terminal, a terminal, a wireless communications device, a user agent, a user apparatus, or the like. It is to be noted that a specific type of the terminal device is not limited in embodiments of the present application.

In some embodiments, the terminal device may be a station (STATION, ST) in a WLAN. In some embodiments, the terminal device may be a cellular phone, a cordless phone, a session initiation protocol (session initiation protocol, SIP) phone, a wireless local loop (wireless local loop, WLL) station, a personal digital assistant (personal digital assistant, PDA) device, a handheld device with a wireless communication function, a computing device, or another processing device connected to a wireless modem, a vehicle-mounted device, a wearable device, a terminal device in a next-generation communications system (such as an NR system), a terminal device in a future evolved public land mobile network (public land mobile network, PLMN), or the like.

In some embodiments, the terminal device may be a device that provides a user with voice and/or data connectivity. For example, the terminal device may be a handheld device, a vehicle-mounted device, or the like that has a wireless connection function. As some specific examples, the terminal device may be a mobile phone (mobile phone), a tablet personal computer (tablet personal computer), a personal computer (personal computer, PC), a laptop computer (laptop computer) or a notebook computer, a personal digital assistant (personal digital assistant, PDA), a palmtop computer, a netbook, an ultra-mobile personal computer (ultra-mobile personal computer, UMPC), a mobile internet device (mobile internet device, MID), a wearable device (wearable device), a robot, a virtual reality (virtual reality, VR) device, an augmented reality (augmented reality, AR) device, a wireless terminal in industrial control (industrial control), a wireless terminal in self driving (self driving), a wireless terminal in remote medical surgery (remote medical surgery), a wireless terminal in smart grid (smart grid), a wireless terminal in transportation safety (transportation safety), a wireless terminal in smart city (smart city), and terminal-side devices such as vehicle UE (vehicle UE, VUE), pedestrian terminal (pedestrian UE, PUE), smart home (home equipment with wireless communications function, such as refrigerator, TV, washing machine or furniture), game machine, teller machine or self-service machine.

As an example, the wearable device includes: smart watches, smart wristbands, smart headphones, smart glasses, smart jewelry (smart bracelets, smart chain bracelets, smart rings, smart necklaces, smart anklets, smart anklet chains, or the like), smart wrist bands, smart clothes, or the like.

In some embodiments, the terminal device may be deployed on land. For example, the terminal device may be deployed indoors or outdoors. In some embodiments, the terminal device may be deployed on water, for example, on a ship. In some embodiments, the terminal device may be deployed in the air, for example, on an airplane, a balloon, and a satellite.

In addition to the terminal device, the communications system may further include one or more network devices. The network device in embodiments of the present application may be a device communicating with the terminal device. The network device may also be called an access network device, a radio access network device, a radio access network (radio access network, RAN), a radio access network function or a radio access network unit. The network device in embodiments of the present application may be a RAN node (or device) that connects the terminal device to a wireless network. The network device may be, for example, a base station, a WLAN access point or a WiFi node. The network device may broadly cover or replace the following names, such as a Node B (NodeB), an evolved NodeB (evolved NodeB, eNB), a next generation NodeB (next generation NodeB, gNB), a relay station, an access point (access point, AP), a base transceiver station (base transceiver station, BTS), a radio base station, a radio transceiver, a basic service set (basic service set, BSS), an extended service set (extended service set, ESS), a home nodeB, a home evolved nodeB, a transmitting and receiving point (transmitting and receiving point, TRP), a transmitting point (transmitting point, TP), a main station (MeNB), a secondary station (SeNB), a multi-standard wireless (multi-standard wireless, MSR) node, a household base station, a network controller, an access node, a wireless node, a transmission node, a transceiver node, a base band unit (base band unit, BBU), a remote radio unit (remote radio unit, RRU), an active antenna unit (active antenna unit, AAU), a remote radio head (remote radio head, RRH), a central unit (central unit, CU), a distributed unit (distributed unit, DU), a positioning node or some other suitable terminology in the field. As long as the same technical effect is achieved, the base station is not limited to specific technical vocabulary. Illustratively, the base station may further be a macro base station, a micro base station, a relay node, a donor node or an analogue, or a combination thereof. The base station may further be a communications module, a modem, or a chip disposed in the device or the apparatus described above. The base station may be a mobile switching center, a device that functions as a base station in D2D, V2X, or M2M communications, a network-side device in a 6G network, a device that functions as a base station in a future communications system, or the like. The base station may support networks with a same access technology or different access technologies. A specific technology and a specific device used by the network device are not limited in embodiments of the present application.

The base station may be fixed or mobile. For example, a helicopter or an unmanned aerial vehicle may function as a mobile base station, and one or more cells may move according to a location of the mobile base station. In other examples, a helicopter or an unmanned aerial vehicle may function as a device in communication with another base station.

In some deployments, the network device in embodiments of the present application may be a CU or a DU, or the network device includes a CU and a DU. The gNB may further include an AAU.

As an example rather than limitation, in embodiments of the present application, the network device may have a mobile characteristic, for example, the network device may be a movable device. In some embodiments of the present application, the network device may be a satellite or a balloon station. In some embodiments of the present application, the network device may alternatively be a base station arranged on land, water, or the like.

In embodiments of the present application, the network device may provide a service for a cell. The terminal device communicates with the network device by using a transmission resource (for example, a frequency resource or a spectrum resource) used by the cell. The cell may be a cell corresponding to the network device (for example, a base station). The cell may belong to a macro station or may belong to a base station corresponding to a small cell (small cell). The small cell herein may include a metro cell (metro cell), a micro cell (micro cell), a pico cell (pico cell), a femto cell (femto cell), or the like. These small cells have characteristics of small coverage and low transmit power, and are suitable for providing a high-rate data transmission service.

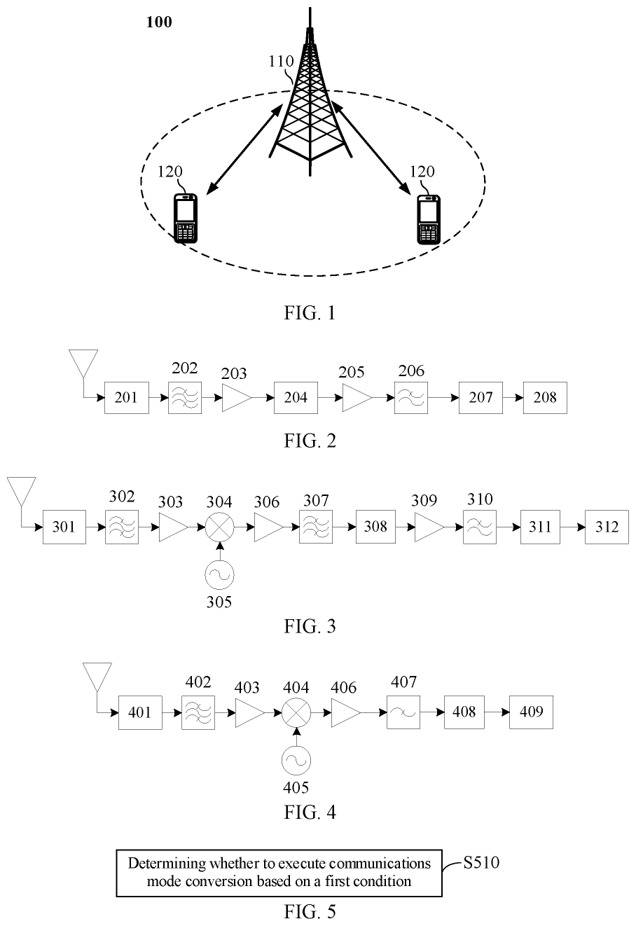

Exemplarily, FIG. 1 is a schematic diagram of an architecture of a communications system according to an embodiment of the present application. As shown in FIG. 1, the communications system 100 may include a network device 110, and the network device 110 may be a device that communicates with a terminal device 120 (or referred to as a communications terminal or a terminal). The network device 110 may provide communication coverage in a specific geographic area, and may communicate with a terminal device located in the coverage.

FIG. 1 exemplarily shows one network device and two terminal devices. In some embodiments of the present application, the communications system 100 may include a plurality of network devices, and another quantity of terminal devices may be included within coverage of each network device. This is not limited herein.

In embodiments of the present application, the network device in the communications system may include an access network device or a core network device. Exemplarily, the communications system shown in FIG. 1 may further include another network entity such as a mobility management entity (mobility management entity, MME) or an access and mobility management function (access and mobility management function, AMF). This is not limited in embodiments of the present application.

It should be understood that a device having a communication function in a network/system in embodiments of the present application may be referred to as a communications device. The communications system 100 shown in FIG. 1 is used as an example. The communications device may include a network device 110 and a terminal device 120 that have a communication function. The network device 110 and the terminal device 120 may be specific devices described above. Details are not described herein again. The communications device may further include another device in the communications system 100, such as a network controller or a mobility management entity, which is not limited in embodiments of the present application.

For ease of understanding, some technical knowledge related to embodiments of the present application is first described. The following related technologies, as optional solutions, may be randomly combined with the technical solutions of embodiments of the present application, all of which fall within the protection scope of embodiments of the present application. Embodiments of the present application include at least a part of the following content.

With the development of mobile communications technology, the application field of internet of things is gradually expanding. However, without the support of an external power supply, 5G devices of internet of things are difficult to be implemented in practice. This is because a 5G device in a cellular network consumes tens of milliwatts of power even if it does not transmit or receive any data. This power consumption is generated since the 5G device has to perform measurements regularly and detect potential paging messages.

In order to reduce the power consumption of the terminal device, a low-power wake-up module and an LP-WUS are introduced in an NR system. The low-power wake-up module is also called a low-power wake-up receiver (low-power wake-up receiver, LP-WUR) or a low-power wake-up radio (low-power wake-up radio, LP-WUR). The receiver may also be called a receiving apparatus. Exemplarily, when the terminal device is idle, a main communications module/receiver of the terminal device may be turned off or set to a deep sleep state, and the LP-WUS is monitored only through the LP-WUR, thus achieving the purpose of reducing the power consumption of the terminal device. The main communications module/receiver of the terminal device may also be called a main radio (main radio, MR), and correspondingly, the low-power wake-up module may also be referred to as LR for short. When the MR is waken up, the terminal device may enter a radio resource control (radio resource control, RRC) connected state. The LP-WUR of the terminal device may be continuously turned on to receive the LP-WUS. Therefore, the LP-WUR may be independent of the 5G device, that is, the 5G device may be turned off when the LP-WUR is active and searching for potential LP-WUS. In order to ensure a low-power performance of the terminal device, it is required to embed an LP-WUS into a related communications system (for example, NR system).

In some embodiments, the LP-WUS may support a bandwidth of 5 MHz to 20 MHz. When the LP-WUS is embedded in the related communications system, the main communications module (or MR) and the low-power wake-up module (LP-WUR or LR) on the terminal device side may be two modules, or may be integrated into one module. The LP-WUR may support a variety of receiver architectures. The LP-WUR is illustrated below by taking three receiver architectures in FIG. 2 to FIG. 4 as examples respectively.

FIG. 2 is a schematic diagram of a structure of an LP-WUR based on radio frequency (radio frequency, RF) envelope detection (envelope detection). The receiver architecture shown in FIG. 2 includes a matching network (matching network) 201, an RF bandpass filter (bandpass filter, BPF) 202, an RF low noise amplifier (low noise amplifier, LNA) 203, an RF envelope detector (envelope detector) 204, baseband (baseband, BB) asymmetric processing (asymmetric processing, AMP) 205, a BB low pass filter (low pass filter, LPF) 206, a 1-bit or multi-bit (1-bit or multi-bit) analog-to-digital converter (analog-to-digital converter, ADC) 207 and digital BB processing (digital BB processing) 208.

In the architecture shown in FIG. 2, an RF signal is directly converted into a baseband signal by the RF envelope detector. Because there is no local oscillator (local oscillator, LO) and phase-locked loop (phase-locked loop, PLL), the power consumption is relatively low. Alternatively, the architecture may include 1-bit or multi-bit ADC, RF LNA and/or BB AMP, high Q matching network and/or RF BPF and/or BB LPF. Alternatively, in order to support multiple frequency bands and/or carriers, multiple high Q matching network and/or RF BPF or multiple off-chip components may be needed, so as to suppress adjacent channel interference or interference from traditional NR signals on adjacent subcarriers and/or another LP-WUS, and support frequency band and/or carrier tuning.

FIG. 3 is a schematic diagram of a structure of an LP-WUR with a heterodyne (heterodyne) architecture (architecture) based on intermediate frequency (intermediate frequency, IF) envelope detection. The receiver architecture shown in FIG. 3 includes a matching network 301, an RF BPF 302, an RF LNA 303, a mixer (mixer) 304, an LO 305, an IF AMP 306, an IF BPF 307, an IF envelope detector 308, a BB AMP 309, a BB LPF 310, a 1-bit or multi-bit ADC 311 and digital BB processing 312.

In the architecture shown in FIG. 3, an RF signal is converted into an intermediate frequency (IF) signal by an RF mixer with an LO. The IF signal is converted into a baseband signal by IF envelope detection. According to the design, there may be one or more intermediate frequency stages, and lower power consumption is achieved by reducing accuracy and stability requirements of the LO. The 1-bit or multi-bit ADC may be applied in this architecture. The high Q matching network and/or the RF BPF and/or the IF BPF (and/or the BB LPF) may be used to suppress adjacent channel interference or interference from traditional NR signals on adjacent subcarriers and/or another LP-WUS. Alternatively, the architecture may adopt some components to improve a sensitivity, such as the RF LNA and/or the IF AMP and/or the BB AMP. Alternatively, frequency band and/or carrier tuning may be achieved through the architecture by tuning a frequency of the LO.

FIG. 4 is a schematic diagram of a structure of an LP-WUR with a homodyne (homodyne) or zero-IF (zero-IF) architecture based on BB (BB) envelope detection. The receiver architecture shown in FIG. 4 includes a matching network 401, an RF BPF 402, an RF LNA 403, a mixer (mixer) 404, an LO 405, a BB AMP 406, a BB LPF/BPF 407, a 1-bit or multi-bit ADC 408 and digital BB processing 409.

In the architecture shown in FIG. 4, frequency band and/or carrier tuning may be achieved by tuning a frequency of the LO. Using the BB BPF/LPF rather than the high Q matching network and/or the RF BPF can suppress adjacent channel interference or interference from traditional NR signals on adjacent subcarriers and/or another LP-WUS more effectively and simply. The RF LNA may be adopted to improve a sensitivity. Baseband envelope detection (not shown in the figure) may be done in an analog domain (before ADC) or a digital domain (after ADC).

With respect to design architecture of the LP-WUR, the LP-WUS may be deployed only in some frequency bands/carriers. For the terminal device, deploying the LP-WUS only in certain frequency bands/operators is beneficial to reduce a cost of the LP-WUR. Due to a limited dynamic range of the terminal device, different RF modules may be needed to support different frequency bands (such as RF filters, LNAs and oscillators in FIGS. 2 to 4), and limited frequency bands may reduce costs. For the network side, deploying the LP-WUS only in certain frequency bands/carriers is beneficial to reduce system overhead. Therefore, it is attractive to allow a quantity of the frequency bands/carriers supported by the LP-WUR to be smaller than that supported by the MR.

In some embodiments, for a terminal device in an idle/inactive mode, cell reselection of the terminal device is not controlled by a network device (e.g., gNB), so the terminal device may freely select a frequency band/carrier for camping.

A plurality of LP-WUR architectures have been introduced above with reference to FIGS. 2 to 4. All LP-WUR architectures may be applied to on-off keying (on-off keying, OOK) modulation. Some architecture may also be applied to another modulation, such as frequency-shift keying (frequency-shift keying, FSK).

The OOK is a well-known modulation method. The OOK may allow implementation of a low-power receiver, i.e., envelope/energy detection. The OOK is a special case of amplitude shift keying (amplitude shift keying, ASK). The OOK has only two amplitudes, which are ON and OFF. When applied to multi-carrier (multi-carrier, MC) systems such as orthogonal frequency division multiple (orthogonal frequency division multiple, OFDM), the OOK is also called a multi-carrier OOK, because ON and OFF signals usually span a plurality of subcarriers.

In some embodiments, in an OFDM-based MC-OOK system, a network node may generate a waveform of multi-carrier amplitude shift keying (MC-ASK) by using coded bits, thereby generating a low-power wake-up signal (LP-WUS).

A plurality of LP-WUR architectures and the generation methods of the LP-WUS are introduced above. For the terminal device, activation/deactivation programs for entering/quitting conditions of the wake-up signal monitoring are standards for the terminal device to decide whether to monitor the LP-WUS in the cell. If the entering/quitting conditions are satisfied, the terminal device may activate/deactivate LP-WUS monitoring. However, how to determine the entering/quitting conditions of the wake-up signal monitoring and how to monitor the LP-WUS by the terminal device are all problems that need to be solved.

On one hand, the terminal device cannot expect to always receive the LP-WUS in the cell. For example, a serving cell that the terminal device is currently located in or about to enter may not support LP-WUS mechanism. For another example, even if the LP-WUS is transmitted in the serving cell, the terminal device may not be able to receive the LP-WUS or fails to receive related reference signals because the terminal device is on an edge of the cell or coverage of the LP-WUR is limited.

On the other hand, the terminal device measures a cell quality by main radio (MR) measurement based on synchronization signal block (synchronization signal block, SSB) or synchronization signal and physical broadcast channel block (synchronization signal and physical broadcast channel block, SSB). However, a measurement result based on SSB may not completely guarantee good coverage of the LP-WUS transmitted by the network device. Because compensation offset between primary synchronization signal (primary synchronization signal, PSS)/secondary synchronization signal (secondary synchronization signal, SSS) and the LP-WUS may be uncertain, a ping-pong situation that the terminal device repeatedly activates and deactivates the LP-WUS monitoring may be caused.

Based on this, embodiments of the present application provide a method for wireless communication. By this method, the terminal device (for example, UE) may determine whether to enter/quit the wake-up signal monitoring based on the measurement result indicating the transmission quality of the wake-up signal, thereby improving a communication effect when the terminal device monitors the low-power wake-up signal for reducing power consumption.

For ease of understanding, the following describes in detail the method provided in embodiments of the present application with reference to FIG. 5. The method shown in FIG. 5 is executed by a terminal device.

The terminal device is any communications terminal that may receive the wake-up signal, and is not limited here. In some embodiments, the terminal device may be in an idle state or an inactive state. For example, the terminal device may be a UE in RRC_IDLE (RRC_IDLE)/RRC_INACTIVE (RRC_INACTIVE) mode. In some embodiments, the terminal device may be in a CONNECTED (CONNECTED) state.

In some embodiments, the terminal device is a communications terminal in the internet of things. A service cell where the terminal device is located may be an NTN cell or a terrestrial network (terrestrial network, TN) cell.

The terminal device may include a first communications module and a second communications module. Exemplarily, the terminal device may include two mutually independent communications modules to reduce power consumption. The first communications module being independent from the second communications module may also be considered as the first communications module being independent from the terminal device. Exemplarily, the first communications module and the second communications module in the terminal device may be integrated together, but a running state and/or an off state of the two communications modules may be set separately.

As an example, the first communications module and the second communications module may be in different states, respectively. Illustratively, when the second communications module is in an off state, the first communications module may be in an active state of searching for a wake-up signal.

In some embodiments, the first communications module and the second communications module perform different functions respectively to reduce power consumption of the terminal device. Exemplarily, the first communications module may receive a low-power wake-up signal (for example, LP-WUS) for waking up the second communications module, and the second communications module is configured to perform paging detection.

As an example, the first communications module is a low-power signal receiving module, and the second communications module is a main communications module of the terminal device. For example, the first communications module belongs to an LP-WUR and the second communications module belongs to an MR. For another example, the first communications module is a low-power wake-up receiver (wake-up receiver, WUR), and the second communications module is an MR.

As an example, the first communications module may adopt any of the receiver architectures described above, such as any one shown in FIG. 2 to FIG. 4.

In some embodiments, the terminal device may include the aforementioned LP-WUR or modules with similar functions to monitor the LP-WUS. The module for monitoring LP-WUS is the first communications module.

In some embodiments, the terminal device may be one of any terminal device group or subgroup. As an example, the terminal device may be any terminal device in a first terminal device subgroup. That is, when the first terminal device subgroup includes a plurality of terminal devices, the terminal device may be one of the plurality of terminal devices. As an example, the terminal device may be any terminal device in a first terminal device group. The first terminal device group may be divided into a plurality of terminal device subgroups. The first terminal device subgroup where the terminal device is located may be configured or dynamically changed.

As an example, the first terminal device group may be some or all terminal devices in an idle state or an inactive state in a certain area. A plurality of terminal devices in the first terminal device group may be classified based on different characteristics to determine a plurality of device subgroups, which is not limited here.

Exemplarily, a plurality of terminal device subgroups may be determined based on wake-up delay of the main communications module of the terminal device. Exemplarily, the plurality of terminal device subgroups may also be determined based on a service type or a service priority of the terminal device.

A wake-up signal or a paging message monitored by the terminal device is transmitted from a network device. The network device may provide services for the cell where the terminal device is located. The network device may be any base station or core network device mentioned above, and is not limited here. For example, the network device may be any of the base stations mentioned above.

In some embodiments, the serving cell where the terminal device is located is a cell or a micro cell where the network device can provide services, and is not limited here.

In some embodiments, the network device may be a communications device supporting an LP-WUS function. Exemplarily, the network device may periodically transmit an LP-WUS in order to wake up the terminal device. Exemplarily, the network device may realize energy-saving configuration associated with the LP-WUS and the PO.

As an example, the cell served by the network device is an NTN cell. For example, the network device may be a satellite covering an area where the terminal device is located in the NTN, or a terrestrial gateway or terrestrial network device communicating with the satellite in the NTN.

In some embodiments, the terminal device and the network device may be relative to each other. Exemplarily, a relay device may also be called a terminal device relative to a network device. Exemplarily, the relay device may also be called a network device relative to a terminal device.

In some embodiments, the network device may transmit paging messages to all terminal devices in the serving cell. When the network device is an access network device such as a base station, the network device may directly transmit paging or receive paging transmitted by a core network. When the network device is a core network device, the network device may transmit paging to the access network device, so that the access network device transmits paging to the terminal device.

Referring to FIG. 5, in step S510, the terminal device determines whether to perform communications mode conversion based on a first condition. The communications mode conversion may also be called communications state conversion. The communications mode conversion may indicate that the terminal device converts from a current communications mode to a new communications mode, so as to satisfy different communications requirements of the terminal device. It can be seen that at least two different communications modes are involved in the communications mode conversion performed by the terminal device.

In some embodiments, the operation of performing the communications mode conversion may be replaced by converting from a first communications mode to a second communications mode. That is, the communications mode conversion refers to conversion between any different communications modes. The first communications mode is a communications mode of the terminal device in a current instant. The second communications mode is a communications mode that the terminal device needs to execute later.

Exemplarily, different communications modes of the terminal device may refer to that different communications modules of the terminal device perform communications. For example, in the first communications mode, communication is performed by the first communications module; and in the second communications mode, communication is performed by the second communications module.

Exemplarily, different communications modes of the terminal device may refer to that r the terminal device needs to perform different communications services. For example, in a first communications mode, the first communications module performs wake-up signal monitoring; in a second communications mode, the first communications module does not perform wake-up signal monitoring; in a third communications mode, the second communications module performs paging detection; and in a fourth communications mode, the second communications module does not perform paging detection.

Exemplarily, in different communications modes of the terminal device, different communications modules of the terminal device are in different states. For example, in the first communications mode, the second communications module of the terminal device is in an off state; and in the second communications mode, the second communications module of the terminal device is in an active state. For another example, in the first communications mode, the first communications module of the terminal device is in an active state; and in the second communications mode, the first communications module of the terminal device is in an off state.

In some embodiments, the communications mode conversion is related to whether the first communications module monitors a communications mode of the wake-up signal. In embodiments of the present application, the wake-up signal monitoring is executed by the first communications module with low-power (for example, LP-WUR).

As an example, the communications mode conversion includes the first communications module entering the wake-up signal monitoring mode and the first communications module quitting the wake-up signal monitoring mode. Thus, the first condition may be used as a condition for the terminal device to activate/deactivate the first communications module to enter/quit the wake-up signal monitoring.

In some embodiments, the wake-up signal is used to wake up the second communications module of the terminal device. It may be seen according to the above description that the second communications module of the terminal device is a main communications module, and waking up the main communications module through the wake-up signal may facilitate the terminal device to enter a deep sleep state or an ultra-deep sleep state, thus realizing energy saving of the terminal device.

In some embodiments, the wake-up signal may be the LP-WUS described above or a signal with similar function to the LP-WUS. For simplicity, the LP-WUS is taken as an example to describe the following content.

As an example, the wake-up signal may be one or more LP-WUSs related to the terminal device. Alternatively, one LP-WUS may be used to indicate whether one or more terminal devices are waken up. A plurality of terminal devices waken up by one LP-WUS may belong to one terminal device group or one terminal device subgroup.

As an example, the terminal device may monitor and receive the wake-up signal through the first communications module, so as to wake up the second communications module configured to perform paging detection before the arrival of the paging message. Waking up the second communications module may refer to changing the second communications module from an off state to an active state, or may refer to triggering the second communications module to monitor the paging message.

It should be understood that since the first communications module of the terminal device may be independent of the terminal device, waking up the second communications module may also be referred as waking up the terminal device. Before receiving the wake-up signal, the second communications module may be in an off state. The terminal device may determine whether to wake up the second communications module according to the received wake-up signal. Alternatively, the wake-up signal may also be used to wake up a module in the terminal device other than the second communications module.

In some embodiments, before determining whether to perform communications mode conversion, the terminal device needs to check whether a serving cell supports transmission of the wake-up signal. For a network device of the serving cell, the network device may determine whether to transmit a wake-up signal to the terminal device based on paging of the terminal device. As an example, information indicating whether the serving cell supports the transmission of the LP-WUS may be included in system information transmitted by a base station.

As an example, when the serving cell supports the transmission of the LP-WUS, the terminal device may determine whether to perform communications mode conversion based on the system information and configuration of an LP-WUS monitor occasion (monitor occasion, MO) of the terminal device. For example, the terminal device may determine whether to monitor the LP-WUS through the first communications module or activate the second communications module to detect the paging message at a paging occasion (paging occasion, PO) according to configuration of the MO.

The first condition is used to determine whether the terminal device performs communications mode conversion, and the first condition may also be called a communications mode conversion condition. Therefore, the first condition may include a condition for converting between any two communications modes by the terminal device.

As an example, the first condition may be used to activate the first communications module to enter the wake-up signal monitoring mode. That is, the first condition may be used as an entry condition for the terminal device to decide wake-up signal detection. For example, if the terminal device decides to monitor the LP-WUS according to the entry condition, the entry condition needs to ensure that the terminal device may receive LP-WUS or similar signals (for example, the LP-SS described later) without lack of coverage when the main radio (main communications module) is in the ultra-deep sleep state. For another example, when a current state of the terminal device meets the first condition, the terminal device may activate the first communications module to monitor the wake-up signal.

As an example, the first condition may be used to deactivate the first communications module to enter the wake-up signal monitoring mode. For example, when the current state of the terminal device does not meet the first condition, the terminal device may cancel the monitoring of the wake-up signal.

As an example, the first condition may be used to activate the first communications module to quit the wake-up signal monitoring mode. That is, the deactivation of the wake-up signal monitoring may be initiated by the terminal device. For example, when the terminal device fails to receive the LP-WUS or the LP-SS due to the limited coverage of the first communications module, the terminal device may trigger a fallback operation, thereby quitting the current wake-up signal monitoring mode. For another example, when the current state of the terminal device meets the first condition, the terminal device may indicate the first communications module to stop monitoring the wake-up signal.

As an example, the first condition may be used to deactivate the first communications module to quit the wake-up signal monitoring mode. For example, when the current state of the terminal device does not meet the first condition, the terminal device may continuously monitor the wake-up signal.

As an implementation of the above examples, when the first condition indicates that the first communications module quits the wake-up signal monitoring mode, an occasion of the communications mode conversion is related to a wake-up time of the second communications module and/or a type of the first communications module. For example, the terminal device may determine the occasion of performing the communications mode conversion according to a wake-up duration of the second communications module from the deep sleep state to a waken-up state and the type of the first communications module, thereby improving communication efficiency.

As an example, the first condition may include system information instructing the terminal device to perform the communications mode conversion and/or configuration of the LP-WUS MO of the terminal device.

The first condition is related to a first measurement result. The first measurement result is related to a measurement signal. In some embodiments, the first measurement result may include a result obtained after the measurement signal is measured by the first communications module and/or the second communications module. In some embodiments, the first measurement result may include a signal quality for realizing energy saving based on a low-power (low-power, LP) mechanism. For example, when the signal quality is expressed by a reference signal received power (reference signal received power, RSRP), the first measurement result obtained based on the low-power mechanism may be expressed as LP-RSRP. The LP-RSRP may be replaced by the RSRP. It should be understood that another signal quality parameter may also be expressed in a similar way.

In some embodiments, a measurement signal corresponding to the first measurement result may include one of the following: a wake-up signal, a synchronization signal related to the first communications module, and a synchronization signal block. The wake-up signal may be the LP-WUS mentioned above.

As an example, a synchronization signal related to the first communications module may be a low-power synchronization signal (low-power synchronization signal, LP-SS) transmitted when the network device supports the low-power mechanism, so the synchronization signal related to the first communications module may also be called a low-power synchronization signal. That is, when the network device supports LP-WUS energy saving, an LP-SS may be transmitted to facilitate the synchronization of the first communications module. Alternatively, the terminal device may execute measurement based on LP-SS to save power.

As an example, the terminal device may determine the configuration information of the LP-SS in various ways. As an implementation, the network device may directly configure an identity (identity, ID) of the LP-SS and/or configure a binary sequence of the LP-SS in broadcast information. As another implementation, the terminal device may identify the LP-SS based on a pre-configured rule. The pre-configured rule may be that an identity of the LP-SS is equal to a (physical cell ID) modulus (configured quantity of candidate LP-SS sequences). In this implementation, by properly configuring the quantity of the candidate LP-SS sequences, the network device may manage an interference between cells that transmit the same LP-SS sequence in a local area.

As an example, the synchronization signal block may be an SSB including a PSS/SSS, or may be a PSS/SSS. The terminal device executes measurement based on SSB, thereby obtaining better accuracy.

In some embodiments, a time domain resource of the measurement signal is aligned with a time domain resource used for synchronization of the second communications module, so that the second communications module is aligned in time after being waken up.

As an example, time/frequency resource grids of the LP-WUS and the LP-SS may assist the second communications module to perform initial timing/frequency calibration. For example, if an occasion edge of the LP-WUS is designated to be aligned with an edge of a symbol/slot/frame of a traditional NR system, the second communications module may immediately implement synchronization at the symbol/slot/frame level when being turned on.

In some embodiments, the terminal device may determine whether to perform communications mode conversion according to a first measurement result of the measurement signal. The terminal device may measure a transmission quality of the LP-WUS based on the LP-WUS and/or the LP-SS, or even the PSS/SSS, so the first measurement result may be used to indicate a transmission quality of the wake-up signal. It can be seen that the two communications modules of the terminal device may measure a quality of a received signal based on the LP-WUS, the LP-SS and/or the PSS/SSS.

As an example, when the terminal device measures through the first communications module, the type of the first communications module is related to a measurement signal that the terminal device may measure. For example, different types of LP-WUR may be applied to different terminal devices. Different types of LP-WURs may receive or measure different types of measurement signals.

As an implementation, the type of the first communications module may include a first type and a second type. When the type of the first communications module is a first type, a measurement signal corresponding to the first measurement result includes a wake-up signal and/or a synchronization signal related to the first communications module; and when the type of the first communications module is a second type, the measurement signal corresponding to the first measurement result includes a synchronization signal block. For example, the LP-WUR may be classified into two different types: LP-WUR type 1 and type 2. A first communications module of the LP-WUR type 1 (first type) cannot receive an OFDM sequence, and a first communications module of the LP-WUR type 2 (second type) may receive an OFDM sequence. In view of a difference between the two different LP-WUR types, different first conditions (communications mode conversion conditions) may be specified. Therefore, different types of LP-WUR affect an activation/deactivation process of the terminal device.

In the above implementation, when receiving the LP-WUS based on an OOK symbol, the LP-WUR type 2 may receive existing PSS/SSS and/or superimposed OFDM sequences. Because of a possibility of sequence detection, the LP-WUR type 2 may have better coverage. For example, if the terminal device has an LP-WUR of type 2, the terminal device may receive an indication from the LP-WUS by combining the OFDM sequence and the OOK symbol. If the LP-WUR of type 2 may execute energy detection and sequence detection, the terminal device with the LP-WUR type 2 may execute detection twice or only once to receive the LP-WUS.

In the above implementation, the terminal device may perform radio resource management (radio resource management, RRM) measurement by receiving an LP-SS and/or a PSS/SSS, which will be described in detail later. For example, when the LP-WUR may receive a PSS/SSS, the terminal device may perform measurement based on the received PSS/SSS. For another example, the terminal device may execute measurement based on LP-SS to save power. For another example, the terminal device may decide whether to wake up the second communications module to receive paging based on the LP-SS measurement and a received paging early indication (paging early indication, PEI).

The first condition is related to the first measurement result indicating the transmission quality of the wake-up signal, so that the terminal device determines whether to enter/quit the wake-up signal monitoring mode according to the predicted/measured transmission quality of the wake-up signal. Alternatively, the first measurement result may directly indicate the transmission quality of the wake-up signal, indirectly indicate the transmission quality of the wake-up signal, or may predict the transmission quality of the wake-up signal.

In some embodiments, the terminal device may determine whether to enter the wake-up signal monitoring mode or whether to quit the wake-up signal monitoring mode based on the first condition. It should be understood that a determination condition for the terminal device to enter the wake-up signal monitoring mode may be different from a determination condition for the terminal device to quit the wake-up signal monitoring mode. In this scenario, the first condition may include a second condition for entering the wake-up signal monitoring mode and a third condition for quitting the wake-up signal monitoring mode. Thus, the second condition may be used to indicate the terminal device to activate/deactivate the first communications module to enter the wake-up signal monitoring mode. The third condition may be used to indicate the terminal device to activate/deactivate the first communications module to quit the wake-up signal monitoring mode.

In some embodiments, when the first measurement result satisfies the second condition, the first communications module is activated to enter the wake-up signal monitoring mode or the second communications module is turned off. When the first measurement result does not satisfy the second condition, the first communications module is deactivated to enter the wake-up signal monitoring mode or keep a current state of the second communications module.

In some embodiments, the second condition may be related to a first threshold, so that the terminal device determines whether to enter the wake-up signal monitoring mode according to the first measurement result of the measurement signal. Before performing the wake-up signal monitoring, the second communications module (MR) is not in a sleep state usually, so measurement of the serving cell based on the measurement signal may be performed by the second communications module. Based on a measurement result and a first threshold, it may be determined whether to change a state of the second communications module to the ultra-deep sleep state, the operation of the first communications module, and whether to activate the LP-WUS monitoring.

Alternatively, the first threshold may be used as an entry threshold for determining whether to start the LP-WUS monitoring. That is, the first threshold may be regarded as a criterion for the terminal device to start LP-WUS monitoring. For the first threshold, in addition to an absolute measurement threshold (such as a signal quality threshold), a measured change value should also be considered to reflect sufficient and stable coverage.

As an embodiment, the first threshold may include one or more of the following: a threshold of a signal quality related to the second communications module; a change threshold of the signal quality related to the second communications module in a time period (for example, a first time period); or a threshold of the signal quality related to the second communications module in a first frequency band.

In the above embodiments, the signal quality may be expressed by an RSRP, a reference signal received quality (reference signal received quality, RSRQ), a received signal strength indication (received signal strength indication, RSSI) or another quality parameter. The first time period may be configured by higher layer signaling. The first frequency band is, for example, a frequency band or inter-frequency related to an operating frequency of the first communications module.

As an implementation, the first threshold may include one or more of the following thresholds: a threshold of the MR RSRP; a change threshold of the MR RSRP in the first time period; the threshold of the MR RSRP and the change threshold of the MR RSRP in the first time period; or a threshold of the MR RSRP/RSRQ measured at the first frequency band or inter-frequency.

In some embodiments, when the first measurement result satisfies the third condition, the first communications module is activated to quit the wake-up signal monitoring mode or the second communications module is waken up. When the first measurement result does not satisfy the third condition, the first communications module is deactivated to quit the wake-up signal monitoring mode or keep the current state of the second communications module.

In some embodiments, the third condition may be related to a second threshold, so that the terminal device determines whether to quit the wake-up signal monitoring mode according to the first measurement result of the measurement signal. Before quitting the wake-up signal monitoring mode, the first communications module (LR) is in an active state, so measurement of the serving cell based on the measurement signal may be performed by the first communications module. In addition, when the terminal device starts the LP-WUS monitoring, MR measurement needs to be relaxed or stopped. If the measurement result of the MR is applicable (for example, based on the measurement result of relaxation), the LR may also know this result and quits the LP-WUS monitoring based on this result.

Alternatively, the second threshold may be used as a quitting threshold for determining whether to quit the LP-WUS monitoring. That is, the second threshold may be set with reference to the measurement change similar to the first threshold.

As an embodiment, the second threshold may include one or more of the following: a threshold of a signal quality related to the first communications module; a change threshold of the signal quality related to the first communications module in a time period (for example, a second time period); or a threshold of a signal quality related to the second communications module. In this embodiment, the signal quality may also be expressed by the RSRP, the RSRQ or another parameter. The second time period may be configured by higher layer signaling.

As an implementation, the second threshold may include one or more of the following thresholds: a threshold of the LR RSRP; a change threshold of the LR RSRP in the second time period; the threshold of the LR RSRP and the change threshold of the LR RSRP in the second time period; or the threshold of the LR RSRP and the threshold of the MR RSRP.

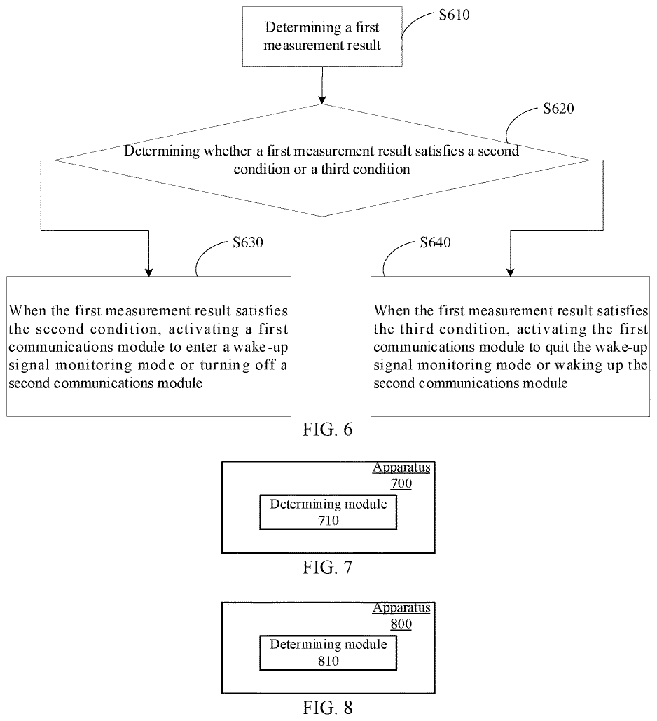

In order to facilitate understanding, the method for performing communications mode conversion by a terminal device will be exemplified below with reference to FIG. 6. Both the second condition and the third condition in FIG. 6 belong to the first condition. The method shown in FIG. 6 is executed by a terminal device.

Referring to FIG. 6, in step S610, a first measurement result is determined.

In step S620, it is determined whether a first measurement result satisfies a second condition or a third condition.

In step S630, when the first measurement result satisfies the second condition, a first communications module is activated to enter a wake-up signal monitoring mode or a second communications module is turned off.

In step S640, when the first measurement result satisfies the third condition, the first communications module is activated to quit the wake-up signal monitoring mode or the second communications module is waken up.

The method for performing the communications mode conversion by the terminal device based on the second condition or the third condition is described above with reference to FIG. 6. For the network device, when the first measurement result meets the second condition, the network device may determine whether to transmit a wake-up signal to the terminal device according to a paging situation of the terminal device. Alternatively, when the first measurement result meets the third condition, the network device may determine whether to transmit a paging message to the terminal device according to the paging situation of the terminal device.

In some embodiments, the first condition may further include one or more of the following: whether the first communications module receives a wake-up signal in a third time period; whether to wake up the second communications module regularly; or whether to execute cell reselection/handover by the terminal device. Exemplarily, the terminal device may determine whether to perform the communications mode conversion according to any one or more of these conditions.

Exemplarily, the terminal device may determine whether to perform the communications mode conversion according to a situation of the wake-up signal monitored by the first communications module. When the terminal device is moved out of the coverage of the LP-WUS and the LP-SS, the network device cannot wake up the second communications module of the terminal device through the LP-WUS. Therefore, one of the conditions for quitting the LP-WUS monitoring may be that the terminal device is not within the coverage of the LP-WUS and the LP-SS. Specifically, when the terminal device fails to receive the LP-WUS within a configured duration, the second communications module should be waken up to search for a paging message for the terminal device, in order to avoid losing the paging message.

Exemplarily, the situation of the wake-up signal monitored by the first communications module may include whether the first communications module receives the wake-up signal within a third time period. The third time period may be a duration configured by a higher layer for monitoring whether a wake-up signal is received. In this scenario, the first condition may be a fallback condition related to the third time period. When the fallback condition is satisfied, the terminal device stops monitoring the LP-WUS.

As an example, the communications mode conversion may include the second communications module entering a paging monitoring mode. When the first communications module fails to receive the wake-up signal within the third time period, the second communications module is activated to enter the paging monitoring mode.

Exemplarily, in some scenarios, the second communications module of the terminal device may need to be waken up regularly to prevent the main communications module of the terminal device from maintaining the ultra-deep sleep state for a long time. As an example, when the first condition indicates a period at which the second communications module needs to be waken up, the terminal device may perform communications mode conversion according to the period.

As an example, a condition that the second communications module needs to be waken up regularly may also be related to the first measurement result. For example, when the first measurement result indicates that the transmission quality of the wake-up signal is good, the second communications module needs to be waken up regularly. For another example, when the first measurement result indicates that the transmission quality of the wake-up signal is poor, the second communications module is unnecessary to be waken up regularly.

Exemplarily, when the first condition indicates that the terminal device needs to perform cell reselection/handover, the terminal device may perform communications mode conversion. For example, when the terminal device needs to perform cell reselection/handover, the terminal device may wake up the second communications module.

As an example, when the first measurement result includes a measurement result of the SSB, the terminal device may determine whether to wake up the second communications module according to the measurement result of the SSB, to perform cell reselection or cell handover. For example, the terminal device may decide whether to wake up the MR to perform cell handover based on the measurement result of the SSB.

As an example, when the first measurement result includes a measurement result of the LP-SS, the terminal device may also determine whether to perform cell handover according to the measurement result of the LP-SS.

In some embodiments, the first measurement result may be a result of measuring a measurement signal within a first time window. Exemplarily, the first measurement result may be a measurement result of the LP-SS performed by the first communications module. The network device may indicate a transmission resource of the LP-SS by configuring the first time window, so as to facilitate the terminal device to determine the measurement signal.

As an example, for the measurement of the LP-SS, a configuration mode of a time window (a first time window) may be used to explicitly indicate the resource of the LP-SS. Illustratively, the first time window may limit a resource size of the LP-SS for measurement. By configuring the first time window, the terminal device does not need to measure each LP-SS.

As an example, the transmission of the LP-SS limited in the first time window may be a transmission dedicated for measurement.

As an example, the first time window may be configured by higher layer signaling. Exemplarily, a starting position and an ending position of the first time window may be directly configured by higher layer signalling. Exemplarily, a specific time slot or symbol resource may be configured as the first time window by higher layer signalling. Further, a slot position of the first time window and a symbol position in the slot may be determined by higher layer signaling.

Taking the measurement of the LP-RSSI for realizing low-power as an example, a frequency resource of the measurement signal used to determine the LP-RSSI may be set to a whole bandwidth (bandwidth, BW), and a time resource of the measurement signal used to determine the LP-RSSI may be limited to the time configuration of the LP-SS. In this example, the entire bandwidth is, for example, 5 MHz. The LP-RSSI may be determined by measuring all symbols in the first time window. Alternatively, the time resource of the measurement signal used to determine the LP-RSSI may be limited to a specific symbol.

In some embodiments, after the first communications module enters the wake-up signal monitoring mode, the terminal device may also determine whether to perform communications mode conversion or cell handover according to the first measurement result. The terminal device has already camped on a cell before entering the wake-up signal monitoring mode. After the terminal device enters the wake-up signal monitoring mode, the first communications module may measure a serving cell in some discontinuous reception (discontinuous reception, DRX) periods based on the LP-SS, and a state of the second communications module is converted to the ultra-deep sleep state to not perform measurement. These DRX periods for measurement based on the LP-SS may be some DRX periods at which the second communications module performs measurement initially.

As an example, when the type of the first communications module is the aforementioned first type, the first communications module may determine whether to perform cell handover or communications mode conversion based on the measurement result of the LP-SS (i.e., the first measurement result) and a plurality of thresholds. Exemplarily, when the first measurement result is greater than or equal to a set third threshold (threshold 1), the terminal device may activate the first communications module for cell handover based on the first measurement result. The cell handover may be performed when the second communications module is in a deep sleep state, thereby handover to a target cell. When the first measurement result is smaller than the third threshold and greater than a set fourth threshold (threshold 2), the terminal device may not perform communications mode conversion. That is, the first measurement result may not be used as a basis for cell handover. However, the terminal device may still maintain a wake-up signal monitoring state without waking up the second communications module. When the first measurement result is smaller than or equal to the fourth threshold, the terminal device activates the first communications module to quit the wake-up signal monitoring mode and wakes up the second communications module. The second communications module may perform measurement and receive paging.

In the above embodiment, after the first communications module enters the wake-up signal monitoring mode, the network device may also perform corresponding operations according to the first measurement result. When the first measurement result is higher than or equal to the third threshold, the network device may receive a cell handover request transmitted by the terminal device. When the first measurement result is smaller than the third threshold and greater than the fourth threshold, the network device may determine whether to transmit a wake-up signal according to a paging situation of the terminal device. When the first measurement result is smaller than or equal to the fourth threshold, the network device may determine whether to transmit a paging message according to the paging situation of the terminal device.

Alternatively, in the process of the cell handover performed by the first communications module, the cell handover may share a random access channel occasion (random access channel occasion, RO) and resources associated with the cell handover performed by the second communications module.

Alternatively, the fourth threshold in the above example may be equal to the second threshold mentioned above.

The method for performing the communications mode conversion by the terminal device based on a plurality of first conditions is described above with reference to FIG. 5 and FIG. 6. When the first condition indicates that the terminal device quits the wake-up signal monitoring mode, the terminal device may wake up the second communications module, so as to carry out relevant communication through the second communications module. However, the terminal device needs a large enough offset to switch from an operation of low-power wake-up occasion (LP-WUS occasion, LO) monitoring to an operation of waking up the second communications module.

In some embodiments, a conversion time required for the terminal device to perform communications mode conversion may be determined according to a type of communications mode conversion that the terminal device needs to perform and/or capability information of the terminal device. Alternatively, the capability information of the terminal device may include the wake-up time of the second communications module and the type of the first communications module.

In some embodiments, the terminal device may determine the type of the communications mode conversion to be performed according to the first condition. For example, when the first condition indicates the terminal device to perform the first communications mode conversion, the first communications mode conversion may include the first communications module quitting the wake-up signal monitoring mode and the second communications module being waken up.

As an example, the first communications mode conversion includes that, when the first communications module quits the wake-up signal monitoring mode and the second communications module is waken up, the conversion time of the first communications mode conversion is related to the wake-up time of the second communications module and/or the type of the first communications module.

Exemplarily, if the second communications module needs to be waken up to monitor the PO, an offset time between the LO and the PO needs to cover a detection time of the wake-up signal, a wake-up time of the second communications module and a resynchronization time. That is, after the terminal device detects the wake-up signal in the LO, the second communications module needs to switch from the ultra-deep sleep mode to the active mode. This requires a large enough offset time to ensure that the second communications module has enough time to be waken up and prepare an indicator (monitoring PO) for monitoring paging.

As an example, the wake-up time of the second communications module may include a time to switch from the ultra-deep sleep mode to the active mode.

As an example, the offset time of the wake-up signal detection and paging monitoring may be a sum of the detection time of the wake-up signal, the wake-up time of the second communications module and the resynchronization time. This offset time may be used to determine a conversion time of the first communications mode conversion.

In some embodiments, different terminal devices may have different conversion time. The second communications modules of different terminal devices may be in different sleep states, depending on positions and service types of the terminal devices. For example, the conversion time of the terminal device may range from tens of milliseconds (such as deep sleep) to hundreds of milliseconds (such as ultra-deep sleep).

In some embodiments, the terminal device may also support a plurality of transition times related to the communications mode conversion. In other words, the terminal device may have different mode conversion time in different scenarios. Alternatively, the setting of the plurality of conversion times may be related to the capability information of the terminal device. For example, when the first condition indicates that the communications mode conversion performed by the terminal device is the first communications mode conversion, the conversion time corresponding to the first communications mode conversion may be determined according to the capability information of the terminal device.

As an example, when the first communications module is an LP-WUR, based on different LP-WUR types/sleep states or service types of the terminal device, a plurality of conversion time or offset time between the PO and the LO may be defined.

As an example, in a scenario where the plurality of conversion time is defined, the terminal device may report relevant capabilities to the network. For example, when the first condition indicates that the communications mode conversion performed by the terminal device is the first communications mode conversion, the network device may determine the conversion time corresponding to the first communications mode conversion from the plurality of conversion time according to the capability information reported by the terminal device.

As an example, the network device needs to know a transition time required to wake up the second communications module. For example, when the first communications module is an LP-WUR and the second communications module is an MR, the transition time may be a time from an instant when the LP-WUR performs LP-WUS processing to an instant when the MR is ready for paging monitoring.

As described above, the conversion time required for the terminal device to perform communications mode conversion is related to the type of the first communications module. In some embodiments, different types of first communications modules affect the conversion time of the terminal device. Exemplarily, some LP-WURs may assist to reduce the conversion time, so the terminal device may have different conversion time. For example, the synchronization time of the second communications module is also related to the type of the first communications module. The second communications module may reduce the conversion time by using time and frequency information of the wake-up signal or the measurement signal, so as to reduce the time for the second communications module to perform the resynchronization process. For example, a better oscillator may be utilized for an OFDM receiver, which has better time/frequency tracking performance than an OOK receiver. Therefore, the resynchronization time of the OFDM receiver may be shorter than that of the OOK receiver.

In some embodiments, for fast convergence, the network device may configure and specify, through system information, a power offset between the SSB and the LP-WUS/LP-SS. For the OOK-based receiver, this offset may assist initial automatic gain control (automatic gain control, AGC) to reduce the synchronization time when the LP-WUS is turned on. For the SSB-based OFDM receiver, this offset may directly assist to realize fast AGC of LP-WUS receiving. Further, the offset may also support LP-WUS/LP-SS transmission through a subset of all SSB beams.

The method for the terminal device to perform communications mode conversion and the conversion time of the second communications module are described above. The terminal device may perform communications mode conversion based on the first measurement result. In some embodiments, when the first measurement result is the measurement result of the measurement signal performed by the first communications module, the first measurement result may be used for performing RRM by the first communications module. That is, the first communications module in the terminal device may perform RRM measurement by receiving the wake-up signal, the LP-SS and/or the PSS/SSS.

For ease of understanding, the method of RRM measurement performed by the first communications module will be exemplified by taking the OOK-based LP-WUR as an example. For the first communications module based on OOK, symbols received by the first communications module may include a first symbol and a second symbol. Exemplarily, the first symbol may be an ON symbol in the OOK, and the second symbol may be an OFF symbol in the OOK. A measured power of the ON symbol may be independent of a sampling rate in a time domain, and the power may include same channel serving and non-serving cell, adjacent channel interference, thermal noise and the like, excluding the power of noise and interference. Power measurement of the OFF symbol may be used to estimate the noise and interference power.

In some embodiments, the terminal device may use an LP-RSRP and an LP-RSRQ as RRM measurements for the OOK-based LP-WUR. In this embodiment, the RRM measurement is performed by the LP-WUR instead of the main communications module, the serving cell measurement of the main communications module may be relaxed. In addition, measurement accuracy of the LP-WUR is high and reliable. If relaxing the RRM measurement by using the LP-WUR is supported, the terminal devices with different types of LP-WURs may perform RRM measurement by receiving the LP-SS and/or the PSS/SSS.

As an example, when the LP-WUR may receive the PSS/SSS, the terminal device with the LP-WUR may perform measurement based on the PSS/SSS received by the LP-WUR.

In some embodiments, the first measurement result may include an RSRP. When the RSRP is an LP-RSRP measured by the first communications module, the LP-RSRP may be an RSRP determined after the terminal device measures a reference signal under a low-power mechanism. Alternatively, a measurement frequency band of the LP-RSRP may be refined within an LP-SS frequency band by using filtering, and any power scaling effect caused by filtering should be eliminated.

As an example, the LP-RSRP may reflect a clean LP-SS signal power after the receiver denoises an originally received LP-SS waveform. The denoising operation may be completed by subtracting the total received power of the OOK OFF symbol from the total received power of the OOK ON symbol. Depending on how the LP-SS is generated at the network device, the limited bandwidth of the LP-SS may cause signal power to leak into the OOK OFF symbol. However, this may only affect an area with a high signal-to-noise ratio, where absolute accuracy of measurement in this area is not important for mobility. When the second communications module needs to reselect a signal noise ratio (signal noise ratio, SNR) area of an adjacent cell, this signal power leakage may be ignored.

As an example, different reference signals may be used for RRM measurement according to the type of the first communications module. When the type of the first communications module is the first type, the existing PSS/SSS may be received, so an existing measurement metrics based on the synchronization signal may be reused. On the other hand, when the type of the first communications module is the first type, the existing PSS/SSS cannot be received. In order to support RRM measurement based on the first communications module, new LP-RSRP and LP-RSSI measurement metrics need to be defined.

Alternatively, the LP-RSRP may be a linear average of the total received power of the LP-SS in the first symbol (e.g., OOK ON symbol), on a frequency resource defined by a quantity of resource elements (resource element, RE) carrying the LP-SS.

Alternatively, the LP-RSSI may be a linear average of the total received power of the LP-SS in the first symbol and the second symbol (e.g., OOK OFF symbol) on the frequency resource defined by the quantity of RE carrying the LP-SS.

For example, a measured power of one OOK symbol should be independent of a time domain sampling rate, that is, the power may be an average power of one sample or a fixed quantity of samples. When the type of the first communications module is the first type, the LP-RSRP may be defined as the linear average of the received power of the LP-SS in the OOK ON symbol, that is, LP-RSRP is the linear average of the received power of the LP-SS in the OOK ON symbol in unit of watts.

As an example, the LP-RSRP may be determined by subtracting the linear average of the total received power in the LP-SS OFF symbol (second symbol) from the linear average of the total received power in the LP-SS ON symbol (first symbol). For example, it is assumed that each ON/OFF symbol has N samples, and the quantities of the ON symbols and the OFF symbols are denoted as M₁ and M₂. If the total power of all samples in one ON symbol or OFF symbol is expressed as P_{ON}(m₁) and P_{OFF}(m₂), where m₁=1, 2, . . . , M₁, and m₂=1, 2, . . . , M₂. When the LP-RSRP is the linear average power of one sample in the ON symbol, the RSRP (that is, LP-RSRP) may be expressed as:

$$RSRP = \frac{1}{N} [ \frac{{\sum }_{{m}_{1} = 1}^{{M}_{1}} {P}_{O N} ( {m}_{1} )}{{M}_{1}} - \frac{{\sum }_{{m}_{2} = 1}^{{M}_{2}} {P}_{O F F} ( {m}_{2} )}{{M}_{2}} ] ,$$

where N represents a total quantity of samples, M₁ represents a quantity of the first symbol, M₂ represents a quantity of the second symbol, P_{ON}(m₁) represents a power of an m₁-th first symbol, and P_{OFF}(m₂) represents a power of an m₂-th second symbol.

In some embodiments, when the RRM measurement is performed through the first communications module, the first measurement result may further include an RSRQ, i.e., LP-RSRQ. In order to calculate the LP-RSRQ, LP-RSSI is also calculated as an intermediate result. As an example, the LP-RSRQ may be calculated as follows: LP-RSRQ=LP-RSRP/LP-RSSI.

As an example, for the calculation of the LP-RSRQ, the LP-RSSI may be determined by the linear average of the total received power in a plurality of LP-SS symbols, and these symbols are noise and interference terms in nature.

As an example, in order to determine the LP-RSRQ, one of the following three options may be defined as LP-RSSI. That is, the RSSI of the RRM measurement performed by the first communications module may be one of the following three definitions.

Definition 1: the RSSI is the linear average of the power of all symbols received by the first communications module. Exemplarily, the LP-RSSI is the linear average of the total received power in all LP-SS OOK symbols. The measured value of the LP-RSSI may be affected by the ON/OFF mode. Even if the total quantities of the OOK symbols are the same, the LP-RSSIs may also be different when the quantities of the ON symbols are different. For example, if the LP-SS does not support Manchester coding, the LP-RSSIs may be different.

Definition 2: the RSSI is the linear average of the power of first symbols received by the first communications module. Exemplarily, the LP-RSSI is the linear average of the total received power in LP-SS OOK OFF symbols. The LP-RSSI may represent noise and interference powers.

Definition 3: the RSSI is the linear average of the power of second symbols received by the first communications module. Exemplarily, the LP-RSSI is the linear average of the total received power in the LP-SS OOK ON symbols. The LP-RSSI may represent pure signal, noise and interference powers.

The foregoing describes the method embodiments of the present application in detail with reference to FIG. 1 to FIG. 6. The following describes in detail the apparatus embodiments of the present application with reference to FIG. 7 to FIG. 9. It should be understood that the description of the apparatus embodiments corresponds to the description of the method embodiments. Therefore, for parts that are not described in detail, one may refer to the foregoing method embodiments.

FIG. 7 is a schematic block diagram of an apparatus for wireless communication according to an embodiment of the present application. The apparatus 700 may be any terminal device described above. The apparatus 700 shown in FIG. 7 includes a determining module 710.

The determining module 710 may be configured to determine whether to execute communications mode conversion based on a first condition; where the terminal device further includes a first communications module and a second communications module, the communications mode conversion includes the first communications module entering a wake-up signal monitoring mode and the first communications module quitting the wake-up signal monitoring mode, the wake-up signal is used to wake up the second communications module, the first condition is related to a first measurement result, and the first measurement result is used to indicate a transmission quality of the wake-up signal.

Alternatively, the first condition includes a second condition for entering the wake-up signal monitoring mode and a third condition for quitting the wake-up signal monitoring mode. The apparatus 700 further includes: a first processing module or a second processing module. The first processing module is configured to: when the first measurement result satisfies the second condition, activate the first communications module to enter the wake-up signal monitoring mode or turn off the second communications module. The second processing module is configured to, when the first measurement result satisfies the third condition, activate the first communications module to quit the wake-up signal monitoring mode or wake up the second communications module.

Alternatively, the second condition is related to a first threshold, and the first threshold includes one or more of the following: a threshold of a signal quality related to the second communications module; a change threshold of the signal quality related to the second communications module in a first time period; or a threshold of the signal quality related to the second communications module in a first frequency band.

Alternatively, the third condition is related to a second threshold, and the second threshold includes one or more of the following: a threshold of a signal quality related to the first communications module; a change threshold of the signal quality related to the first communications module in a second time period; or a threshold of a signal quality related to the second communications module.

Alternatively, a measurement signal corresponding to the first measurement result includes one of the following: a wake-up signal, a synchronization signal related to the first communications module, or a synchronization signal block.

Alternatively, a time domain resource of the measurement signal is aligned with a time domain resource for synchronizing of the second communications module.

Alternatively, the terminal device supports a plurality of conversion time related to the communications mode conversion; and when the first condition indicates that the terminal device executes first communications mode conversion, a conversion time of the first communications mode conversion is determined according to capability information of the terminal device.

Alternatively, when the first communications mode conversion includes that the first communications module quits the wake-up signal monitoring mode and the second communications module is waken up, the conversion time of the first communications mode conversion is related to a wake-up time of the second communications module and/or a type of the first communications module.

Alternatively, when the type of the first communications module is a first type, a measurement signal corresponding to the first measurement result includes a wake-up signal and/or a synchronization signal related to the first communications module; and when the type of the first communications module is a second type, the measurement signal corresponding to the first measurement result includes a synchronization signal block.

Alternatively, the first condition further includes one or more of the following: whether the first communications module receives a wake-up signal in a third time period; whether to wake up the second communications module regularly; or whether to execute cell reselection/handover by the terminal device.

Alternatively, the communications mode conversion further includes the second communications module entering a paging monitoring mode, and the apparatus 700 further includes a third processing module, activating the second communications module to enter the paging monitoring mode, when the first communications module fails to receive the wake-up signal in the third time period.

Alternatively, after the first communications module enters the wake-up signal monitoring mode, the apparatus 700 further includes a fourth processing module, a fifth processing module and a sixth processing module. The fourth processing module is configured to: when the first measurement result is greater than or equal to a third threshold, activate the first communications module to perform cell handover. The fifth processing module is configured to: when the first measurement result is smaller than the third threshold and greater than a fourth threshold, skip executing the communications mode conversion. The sixth processing module is configured to: when the first measurement result is smaller than or equal to the fourth threshold, activate the first communications module to quit the wake-up signal monitoring mode and wake up the second communications module.

Alternatively, the first measurement result is a measurement result of a measurement signal performed by the first communications module, and the first measurement result is used for the first communications module to perform radio resource management.

Alternatively, symbols received by the first communications module include a first symbol and a second symbol, the first measurement result includes an RSRP, and the RSRP is:

$$RSRP = \frac{1}{N} [ \frac{{\sum }_{{m}_{1} = 1}^{{M}_{1}} {P}_{O N} ( {m}_{1} )}{{M}_{1}} - \frac{{\sum }_{{m}_{2} = 1}^{{M}_{2}} {P}_{O F F} ( {m}_{2} )}{{M}_{2}} ] ,$$

where N represents a total quantity of samples, M₁ represents a quantity of the first symbol, M₂ represents a quantity of the second symbol, P_{ON}(m₁) represents a power of an m₁-th first symbol, and P_{OFF}(m₂) represents a power of an m₂-th second symbol.

Alternatively, symbols received by the first communications module include a first symbol and a second symbol, the first measurement result includes an RSSI, and the RSSI includes one of the following: a linear average of powers of all symbols received by the first communications module; a linear average of powers of the first symbols received by the first communications module; or a linear average of powers of the second symbols received by the first communications module.

Alternatively, the first measurement result is a measurement result of a measurement signal in a first time window, and the first time window is configured by higher layer signalling.

FIG. 8 is a schematic block diagram of another apparatus for wireless communication according to an embodiment of the present application. The apparatus 800 may be any network device described above. The apparatus 800 shown in FIG. 8 includes a determining module 810.

The determining module 810 may be configured to determine whether to transmit a wake-up signal to a terminal device based on paging of the terminal device; where the terminal device includes a first communications module and a second communications module, the wake-up signal is used to wake up the second communications module, a first measurement result is used to indicate a transmission quality of the wake-up signal, a first condition is related to the first measurement result, the first condition is used for the terminal device to determine whether to perform communications mode conversion, the communications mode conversion includes the first communications module entering a wake-up signal monitoring mode and the first communications module quitting the wake-up signal monitoring mode.

Alternatively, the first condition includes a second condition for entering the wake-up signal monitoring mode and a third condition for quitting the wake-up signal monitoring mode. The determining module 810 is further configured to: when the first measurement result satisfies the second condition, determine whether to transmit a wake-up signal to the terminal device; or, when the first measurement result satisfies the third condition, determine whether to transmit a paging message to the terminal device.

Alternatively, the second condition is related to a first threshold, and the first threshold includes one or more of the following: a threshold of a signal quality related to the second communications module; a change threshold of the signal quality related to the second communications module in a first time period; or a threshold of the signal quality related to the second communications module in a first frequency band.

Alternatively, the third condition is related to a second threshold, and the second threshold includes one or more of the following: a threshold of a signal quality related to the first communications module; a change threshold of the signal quality related to the first communications module in a second time period; or a threshold of a signal quality related to the second communications module.

Alternatively, a measurement signal corresponding to the first measurement result includes one of the following: a wake-up signal, a synchronization signal related to the first communications module, and a synchronization signal block.

Alternatively, a time domain resource of the measurement signal is aligned with a time domain resource for synchronizing of the second communications module.

Alternatively, the terminal device supports a plurality of conversion time related to the communications mode conversion; and when the first condition indicates that the terminal device executes first communications mode conversion, a conversion time of the first communications mode conversion is determined according to capability information of the terminal device.

Alternatively, when the first communications mode conversion includes that the first communications module quits the wake-up signal monitoring mode and the second communications module is waken up, the conversion time of the first communications mode conversion is related to a wake-up time of the second communications module and/or a type of the first communications module.

Alternatively, when the type of the first communications module is a first type, a measurement signal corresponding to the first measurement result includes a wake-up signal and/or a synchronization signal related to the first communications module; and when the type of the first communications module is a second type, the measurement signal corresponding to the first measurement result includes a synchronization signal block.

Alternatively, the first condition further includes one or more of the following: whether the first communications module receives a wake-up signal in a third time period; whether to wake up the second communications module regularly; or whether to execute cell reselection/handover by the terminal device.

Alternatively, the communications mode conversion further includes the second communications module entering the paging monitoring mode, and whether the first communications module receives the wake-up signal in the third time period is used to determine whether the second communications module enters the paging monitoring mode.

Alternatively, after the first communications module enters the wake-up signal monitoring mode, the determining module 810 is further configured to: when the first measurement result is greater than or equal to a third threshold, receive a cell handover request; when the first measurement result is smaller than the third threshold and greater than a fourth threshold, determine whether to transmit the wake-up signal; and when the first measurement result is smaller than or equal to the fourth threshold, determine whether to transmit the paging message.

Alternatively, the first measurement result is a measurement result of a signal performed by the first communications module, and the first measurement result is used for the first communications module to perform radio resource management.

Alternatively, symbols received by the first communications module include a first symbol and a second symbol, the first measurement result includes an RSRP, and the RSRP is:

$$RSRP = \frac{1}{N} [ \frac{{\sum }_{{m}_{1} = 1}^{{M}_{1}} {P}_{O N} ( {m}_{1} )}{{M}_{1}} - \frac{{\sum }_{{m}_{2} = 1}^{{M}_{2}} {P}_{O F F} ( {m}_{2} )}{{M}_{2}} ] ,$$

where N represents a total quantity of samples, M₁ represents a quantity of the first symbol, M₂ represents a quantity of the second symbol, P_{ON}(m₁) represents a power of an m₁-th first symbol, and P_{OFF}(m₂) represents a power of an m₂-th second symbol.

Alternatively, symbols received by the first communications module include a first symbol and a second symbol, the first measurement result includes an RSSI, and the RSSI includes one of the following: a linear average of powers of all symbols received by the first communications module; a linear average of powers of the first symbols received by the first communications module; or a linear average of powers of the second symbols received by the first communications module.

Alternatively, the first measurement result is a measurement result of a measurement signal in a first time window, and the first time window is configured by higher layer signalling.

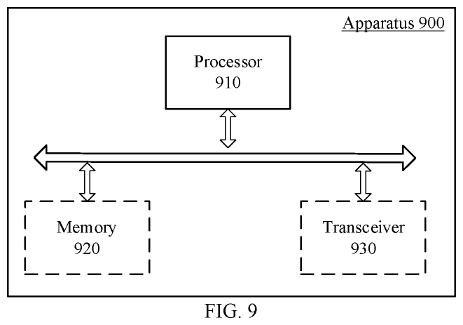

FIG. 9 is a schematic structural diagram of a communications apparatus according to an embodiment of the present application. Dashed lines in FIG. 9 indicate that a unit or module is optional. The apparatus 900 may be configured to implement the method described in the foregoing method embodiment. The apparatus 900 may be a chip, a terminal device, or a network device.

The apparatus 900 may include one or more processors 910. The processor 910 may support the apparatus 900 in implementing the method described in the foregoing method embodiment. The processor 910 may be a general-purpose processor or a dedicated processor. For example, the processor may be a central processing unit (central processing unit, CPU). Alternatively, the processor may be another general-purpose processor, a digital signal processor (digital signal processor, DSP), an application-specific integrated circuit (application specific integrated circuit, ASIC), a field-programmable gate array (field programmable gate array, FPGA) or another programmable logic device, a discrete gate or transistor logic device, a discrete hardware component, or the like. The general-purpose processor may be a microprocessor, or the processor may be any conventional processor or the like.

The apparatus 900 may further include one or more memories 920. The memory 920 stores a program, and the program may be executed by the processor 910, so that the processor 910 performs the method described in the foregoing method embodiments. The memory 920 may be separate from or integrated into the processor 910.

The apparatus 900 may further include a transceiver 930. The processor 910 may communicate with another device or chip through the transceiver 930. For example, the processor 910 may transmit data to and receive data from another device or chip through the transceiver 930.

An embodiment of this application further provides a computer-readable storage medium for storing a program. The computer-readable storage medium may be applied to the terminal device or the network device provided in embodiments of the present application, and the program causes a computer to execute the method executed by the terminal device or the network device in various embodiments of the present application.

The computer-readable storage medium may be any available medium accessible by a computer or a data storage device such as a server or a data center that integrates one or more available media. The available medium may be a magnetic medium (for example, a floppy disk, a hard disk, or a magnetic tape), an optical medium (for example, a digital video disc (digital video disc, DVD)), a semiconductor medium (for example, a solid state disk (solid state disk, SSD)), or the like.

An embodiment of the present application further provides a computer program product. The computer program product includes a program. The computer program product may be applied to the terminal device or the network device provided in embodiments of the present application, and the program causes a computer to execute the methods executed by the terminal device or the network device in various embodiments of the present application.

All or some of the foregoing embodiments may be implemented by using software, hardware, firmware, or any combination thereof. When the software is used to implement embodiments, all or some of embodiments may be implemented in a form of a computer program product. The computer program product includes one or more computer instructions. When the computer program instructions are loaded and executed on a computer, the procedures or functions according to embodiments of the present application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from one website, computer, server, or data center to another website, computer, server, or data center in a wired (such as a coaxial cable, an optical fiber, and a digital subscriber line (digital subscriber line, DSL)) manner or a wireless (such as infrared, wireless, and microwave) manner.

An embodiment of the present application further provides a computer program. The computer program may be applied to the terminal device or the network device provided in embodiments of the present application, and the computer program causes a computer to execute the methods executed by the terminal device or the network device in various embodiments of the present application.

The terms “system” and “network” in the present application may be used interchangeably. In addition, the terms used in the present application are merely used to explain the specific embodiments of the present application, and are not intended to limit the present application. In the specification, claims, and accompanying drawings of the present application, the terms “first”, “second”, “third”, “fourth”, and so on are intended to distinguish between different objects but do not describe a particular order. In addition, the terms “include” and “have” and any variations thereof are intended to cover a non-exclusive inclusion.

In embodiments of the present application, “indicate” mentioned herein may be a direct indication, or may be an indirect indication, or may mean that there is an association relationship. For example, A indicates B, which may mean that A directly indicates B, for example, B may be obtained by using A; or may mean that A indirectly indicates B, for example, A indicates C, and B may be obtained by using C; or may mean that there is an association relationship between A and B.

In embodiments of the present application, the term “corresponding” may mean that there is a direct or indirect correspondence between two elements, or that there is an association between two elements, or that there is a relationship of “indicating” and “being indicated”, “configuring” and “being configured”, or the like.

In embodiments of the present application, “pre-defining” or “pre-configuring” may be implemented by pre-storing corresponding codes, tables, or other forms that may be used to indicate related information in devices (for example, including a terminal device and a network device). A specific implementation thereof is not limited in the present application. For example, being pre-defined may refer to being defined in a protocol.

In embodiments of the present application, the “protocol” may indicate a standard protocol in the communication field, which may include, for example, an LTE protocol, an NR protocol, and a related protocol applied to a future communications system. This is not limited in the present application.

In embodiments of the present application, determining B based on A does not mean determining B based on only A, but instead B may be determined based on A and/or other information.

In embodiments of the present application, the term “and/or” is merely an association relationship that describes associated objects, and represents that there may be three relationships. For example, A and/or B may represent three cases: only A exists, both A and B exist, and only B exists. In addition, the character “/” in this specification generally indicates an “or” relationship between the associated objects.

In embodiments of the present application, sequence numbers of the foregoing processes do not mean execution orders. The execution orders of the processes should be determined based on functions and internal logic of the processes, and should not be construed as any limitation on the implementation processes of embodiments of the present application.

In several embodiments provided in the present application, it should be understood that, the disclosed system, apparatus, and method may be implemented in other manners. For example, the foregoing described apparatus embodiments are merely examples. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. Indirect couplings or communication connections between apparatuses or units may be implemented in electrical, mechanical, or other forms.

The units described as separate parts may be or may not be physically separate, and parts displayed as units may be or may not be physical units, and may be at one location, or may be distributed on a plurality of network elements. Some or all of the units may be selected according to actual requirements to achieve the objectives of the solutions of embodiments.

In addition, functional units in embodiments of the present application may be integrated into one processing unit, or each of the units may exist alone physically, or two or more units may be integrated into one unit.

The foregoing descriptions are merely specific implementations of the present application, but the protection scope of the present application is not limited thereto. Any variation or replacement readily figured out by a person skilled in the art within the technical scope disclosed in the present application shall fall within the protection scope of the present application. Therefore, the protection scope of the present application shall be subject to the protection scope of the claims.

What is claimed is:

1. A method for wireless communication, wherein the method comprises:
obtaining, by a terminal device while in a wake-up signal monitoring mode, a first measurement result of a measurement signal received by a first communications module, wherein the measurement signal comprises at least one of a wake-up signal, a synchronization signal related to the first communications module, or a synchronization signal block, and the first measurement result indicates a transmission quality of the wake-up signal;
determining, by the terminal device and based on the first measurement result, whether a first condition for communications module conversion is satisfied, wherein the first condition is related to the first measurement result.

2. The method of claim 1, wherein the measurement signal comprises the wake-up signal,
and the wake-up signal is used to wake up a second communications module to monitor a paging message in a paging monitoring occasion associated with the wake-up signal.

3. The method according to claim 1, wherein the first condition comprises a second condition for entering the wake-up signal monitoring mode and a third condition for exiting the wake-up signal monitoring mode, and the method further comprises:
when the first measurement result satisfies the second condition, performing the communications module conversion by turning off a second communications module; or
when the first measurement result satisfies the third condition, performing the communications module conversion by waking up the second communications module.

4. The method according to claim 3, wherein the second condition is related to a first threshold, and the first threshold comprises one or more of the following:
a threshold of a signal quality related to the second communications module;
a change threshold of the signal quality related to the second communications module in a first time period; or
a threshold of the signal quality related to the second communications module in a first frequency band.

5. The method according to claim 3, wherein the third condition is related to a second threshold, and the second threshold comprises one or more of the following:
a threshold of a signal quality related to the first communications module;
a change threshold of the signal quality related to the first communications module in a second time period; or
a threshold of a signal quality related to the second communications module.

6. The method according to claim 1, wherein a measurement signal corresponding to the first measurement result comprises one of the following: a wake-up signal, a synchronization signal related to the first communications module, or a synchronization signal block.

7. The method according to claim 6, wherein a time domain resource of the measurement signal is synchronously aligned with a time domain resource of a second communications module.

8. The method according to claim 1, wherein the terminal device supports a plurality of conversion time related to the communications module conversion; and when the first condition indicates that the terminal device executes first communications module conversion, a conversion time of the first communications module conversion is determined according to capability information of the terminal device.

9. The method according to claim 1, wherein when the first communications module conversion comprises that the first communications module exiting the wake-up signal monitoring mode and a second communications module being waken up, a conversion time of the first communications module conversion is related to at least one of a wake-up time of the second communications module or a type of the first communications module.

10. The method according to claim 9, wherein when the type of the first communications module is a first type, a measurement signal corresponding to the first measurement result comprises at least one of a wake-up signal or a synchronization signal related to the first communications module; and when the type of the first communications module is a second type, the measurement signal corresponding to the first measurement result comprises a synchronization signal block.

11. The method according to claim 1, wherein the first condition further comprises one or more of following:
whether the first communications module receives a wake-up signal in a third time period;
whether to wake up a second communications module regularly; or
whether to execute cell reselection or handover by the terminal device.

12. The method according to claim 11, wherein the communications module conversion further comprises the second communications module entering a paging monitoring mode, and the method further comprises:
when the first communications module fails to receive the wake-up signal in the third time period, activating the second communications module to enter the paging monitoring mode.

13. The method according to claim 1, wherein after the first communications module enters the wake-up signal monitoring mode, the method further comprises:
when the first measurement result is greater than or equal to a third threshold, activating the first communications module to perform cell handover;
when the first measurement result is smaller than the third threshold and greater than a fourth threshold, skipping executing the communications module conversion; and
when the first measurement result is smaller than or equal to the fourth threshold, activating the first communications module to quit the wake-up signal monitoring mode and waking up a second communications module.

14. The method according to claim 13, wherein symbols received by the first communications module comprise a first symbol and a second symbol, the first measurement result comprises a reference signal received power (RSRP), and the RSRP is:
$$RSRP = \frac{1}{N} [ \frac{{\sum }_{{m}_{1} = 1}^{{M}_{1}} {P}_{O N} ( {m}_{1} )}{{M}_{1}} - \frac{{\sum }_{{m}_{2} = 1}^{{M}_{2}} {P}_{O F F} ( {m}_{2} )}{{M}_{2}} ] ,$$
wherein N represents a total quantity of samples, M₁ represents a quantity of the first symbol, M₂ represents a quantity of the second symbol, P_{ON}(m₁) represents a power of an m₁-th first symbol, and P_{OFF}(m₂) represents a power of an m₂-th second symbol.

15. The method according to claim 13, wherein symbols received by the first communications module comprise a first symbol and a second symbol, the first measurement result comprises a received signal strength indication (RSSI), and the RSSI comprises one of the following:
a linear average of powers of all symbols received by the first communications module;
a linear average of powers of the first symbols received by the first communications module; or
a linear average of powers of the second symbols received by the first communications module.

16. The method according to claim 15, wherein the first measurement result is a measurement result of a measurement signal in a first time window, and the first time window is configured by higher layer signalling.

17. A wireless communication method, comprising:
determining whether to transmit a wake-up signal to a terminal device based on paging of the terminal device,
wherein the terminal device comprises a first communications module and a second communications modules, the wake-up signal is used to wake up the second communications module, a first measurement result indicates a transmission quality of the wake-up signal, a first condition is related to the first measurement result, the first condition is used for the terminal device to determine whether to perform communications module conversion, the communications module conversion comprises the first communications module entering a wake-up signal monitoring mode or the first communications module exiting the wake-up signal monitoring mode.

18. A terminal device, comprising:
at least one processor; and
one or more non-transitory computer-readable storage media coupled to the at least one processor and storing programming instructions for execution by the at least one processor, wherein the programming instructions, when executed, cause the terminal device to perform operations comprising:
obtaining, while in a wake-up signal monitoring mode, a first measurement result of a measurement signal received by a first communications module, wherein the measurement signal comprises at least one of a wake-up signal, a synchronization signal related to the first communications module, or a synchronization signal block, and the first measurement result indicates a transmission quality of the wake-up signal;
determining, based on the first measurement result, whether a first condition for communications module conversion is satisfied, wherein the first condition is related to the first measurement result.

19. The terminal device of claim 18, wherein the measurement signal comprises the wake-up signal,
and the wake-up signal is used to wake up a second communications module to monitor a paging message in a paging monitoring occasion associated with the wake-up signal.

20. The terminal device according to claim 19, wherein the first condition comprises a second condition for entering the wake-up signal monitoring mode and a third condition for exiting the wake-up signal monitoring mode, and the operations comprise:
when the first measurement result satisfies the second condition, performing the communications module conversion by turning off a second communications module; or
when the first measurement result satisfies the third condition, performing the communications module conversion by waking up the second communications module.
